(19) United States
(12) Patent Application Publication
(10) Pub. No.: US 2009/0243337 A1
(43) Pub. Date: Oct. 1, 2009

(54) FRAME WITH CLOSED CROSS-SECTION

(75) Inventors: Mitsuhiro Ema, Kanagawa (JP); Yoshihaya Imamura, Yamaguchi (JP); Toru Hashimura, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 12/293,472

(22) PCT Filed: Mar. 29, 2007
(86) PCT No.: PCT/JP2007/056808

§ 371 Date: Sep. 18, 2008

(30) Foreign Application Priority Data
Mar. 30, 2006 (JP) 2006-094614

(51) Int. Cl. B62D 21/15

(52) U.S. Cl. 296/187.12

(57) ABSTRACT

There is provided a frame having closed cross-sections capable of preventing a welded joint of the frame from being turned in a wide open state, or being broken when an external force is applied to the frame at the time of vehicle collision, and so forth, and the frame is collapsed. The frame having closed cross-sections is provided with a body cylindrical in shape, wherein first side parts of a first frame member, in pairs, are welded to second side parts of a second frame member, in pairs, respectively, thereby forming a welded joint on both sides of the body, and respective end faces of each of the reinforcing plates, in the widthwise direction of the body, are butted against respective inner side faces of the side parts of the body, corresponding thereto.

### TECHNICAL FIELD

The invention relates to a frame having closed cross-sections such as an automobile body frame, suspension frame, and so forth.

### BACKGROUND ART

The body of the automobile, and so forth is provided with high-strength hollow members, such as a body frame, particularly, a side frame (side member), crush box, bumper stay, suspension frame, and so forth, responsible of absorbing an impact energy by collapsing in the longitudinal direction (the axial direction) of the frame at the time of vehicle collision in order to ensure safety of crew. There has lately been proposed an energy-absorbing member formed of an extruded shape made of an aluminum alloy, serving as those high-strength hollow members from a standpoint of further reduction in weight of a vehicle body (for example, Patent Document 1).

However, there is a problem in that an extruded shape for use in the energy-absorbing member is suitable for an energy-absorbing member such as the bumper stay, and so forth, linear in the axial direction thereof, but, for example, a front side frame (side member) of a passenger car, and so forth are bent in the axial direction thereof, so that a linear extruded shape need be formed by bending, and high accuracy of finishing is required besides a high processing cost. Further, there is another problem in that since the extruded shape becomes constant in cross-section shape, it will be difficult to change the cross-section shape thereof according to regions where strength is required of members, and regions where members are attached, thereby imposing constraints on designing of frames.

Accordingly, there has been proposed an energy-absorbing member wherein two members each having open cross-sections, formed by pressing and so forth, of a sheet material, are joined together by spot welding, arc welding or laser welding, and so forth, thereby forming closed cross-sections (for example, Patent Document 2, Patent Document 3, and Patent Document 4).

Further, from a standpoint of enhancement in performance of an energy-absorbing member, there has been proposed a method for enhancing energy absorption performance of the energy-absorbing member by providing the same with a fragile region such as a notch, and so forth (for example, Patent Document 5), a method for enhancing energy absorption performance of the energy-absorbing member by use of a reinforcing member provided with a fragile region (for example, Patent Document 6), and so forth.

However, although respective structures disclosed in conventional techniques described as above is greater in flexibility in designing cross-section than the frame made up of an extruded shape, there arises a problem in that a weld zone will be wide open when an external force is applied to a frame upon vehicle collision, and so forth, to be subsequently collapsed because the weld zone where stress is prone to converge is weaker than a base metal zone (non-weld zone) if an energy-absorbing member of the structure described as above is made of an aluminum alloy. Further, a problem exists in that if the weld zone is in a wide open state, and collapsed, there is not only a risk of deterioration in energy absorption performance upon formation of an opening, and breakage of the weld zone, but also a risk of the opening being turned into a sharp ruptured face to thereby cause injury to passengers, and impairing an ambient environment if the ruptured face is exposed.

Patent Document 1: JP-A No. 2004-203202

Patent Document 2: JP-A No. 7 (1995)-310156

Patent Document 3: JP-A No. 11 (1999)-208504

Patent Document 4: JP-A No. 2003-175858

Patent Document 5: JP-A No. 3 (1991)-65634

Patent Document 6: P-A No. 11 (1999)-342862

### DISCLOSURE OF THE INVENTION

In light of those problems described as above, the invention has been developed, and it is an object of the invention to provide a frame having closed cross-sections capable of preventing a welded joint of the frame from being turned in a wide open state, or being broken when an external force is applied to the frame at the time of vehicle collision, and so forth, and the frame is collapsed.

In accordance with one aspect of the invention, there is provided a frame having closed cross-sections, provided with a body cylindrical in shape, the frame including a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located. And the internal reinforcing member comprises plural reinforcing plates disposed in such a way as to intersect the axial direction of the body, and at equal intervals in the axial direction of the body, respective end faces of each of the reinforcing plates, in the widthwise direction of the body, having a portion butted against the inner side face of the second side part, corresponding thereto, and a portion disposed so as to be isolated from the inner side face of the first side part, corresponding thereto, and one end face of the reinforcing plate, in the direction of height, orthogonal to the widthwise direction of the body, is butted against the inner side face of the first bottom while the other end face thereof is butted against the inner side face of the second bottom.

### BRIEF DESCRIPTION OF THE DRAWINGS

FIG. 1 is a schematic perspective view showing a frame having closed cross-sections, according to a first embodiment of the invention.

FIG. 2 is an enlarged view showing a region indicated by the arrow II in FIG. 1.

FIG. 3 is a schematic side view showing the frame shown in FIG. 1.

FIG. 4 is a cross-sectional view taken on line IV-IV in FIG. 3.

FIG. 5 is a schematic perspective view showing a frame having closed cross-sections, according to a second embodiment of the invention.

FIG. 6 is an enlarged view showing a region indicated by the arrow VI in FIG. 5.

FIG. 7 is a schematic side view showing the frame shown in FIG. 5.

FIG. 8 is a cross-sectional view taken on line VIII-VIII in FIG. 7.

FIG. 9 is a schematic side view showing a frame having closed cross-sections, according to a third embodiment of the invention.

FIG. 10 is a cross-sectional view taken on line X-X in FIG. 9.

FIG. 11 is a schematic side view showing a frame having closed cross-sections, according to the third embodiment of the invention.

FIG. 12 is a cross-sectional view taken on line XII-XII in FIG. 11.

FIG. 13 is a schematic side view showing a frame having closed cross-sections, according to a fourth embodiment of the invention.

FIG. 14 is a cross-sectional view taken on line XIV-XIV in FIG. 13.

FIG. 15 is a schematic side view showing a frame having closed cross-sections, according to a fifth embodiment of the invention.

FIG. 16 is a cross-sectional view taken on line XVI-XVI in FIG. 15.

FIG. 17 is a schematic side view showing a frame having closed cross-sections, according to a sixth embodiment of the invention.

FIG. 18 is a cross-sectional view taken on line XVIII-XVIII in FIG. 17.

FIG. 19 is a schematic perspective view showing an internal reinforcing member according to the sixth embodiment of the invention.

FIG. 20 is a schematic side view showing a frame having closed cross-sections, according to a seventh embodiment of the invention.

FIG. 21 is a cross-sectional view taken on line XXI-XXI in FIG. 20.

FIG. 22 is a schematic perspective view showing a frame having closed cross-sections, according to Comparative Example 1.

FIG. 23 is an enlarged view showing a region indicated by the arrow XXIII in FIG. 22.

FIG. 24 is a schematic perspective view showing a frame having closed cross-sections, according to Comparative Example 2.

FIG. 25 is an enlarged view showing a region indicated by the arrow XXV in FIG. 24.

FIG. 26 is a schematic perspective view showing a state of breakage of the frame having closed cross-sections, according to Working Example 2.

FIG. 27 is a cross-sectional view taken on line XXVII-XXVII in FIG. 26.

FIG. 28 is an enlarged view showing a region indicated by the arrow XXVIII in FIG. 27.

FIG. 29 is a cross-sectional view taken on line XXIX-XXIX in FIG. 26.

FIG. 30 is an enlarged view showing a region indicated by the arrow XXX in FIG. 29.

FIG. 31 is a schematic perspective view showing a state of breakage of a frame having closed cross-sections, according to Working Example 2.

FIG. 32 is a cross-sectional view taken on line XXXII-XXXII in FIG. 31.

FIG. 33 is an enlarged view showing a region indicated by the arrow XXXIII in FIG. 32.

FIG. 34 is a schematic top view showing a state of breakage of a frame having closed cross-sections, according to Working Example 7.

FIG. 35 is a schematic left side view of the frame having closed cross-sections, shown in FIG. 34.

### BEST MODE FOR CARRYING OUT THE INVENTION

Embodiments of the invention are specifically described hereinafter with reference to the accompanying drawings.

### First Embodiment

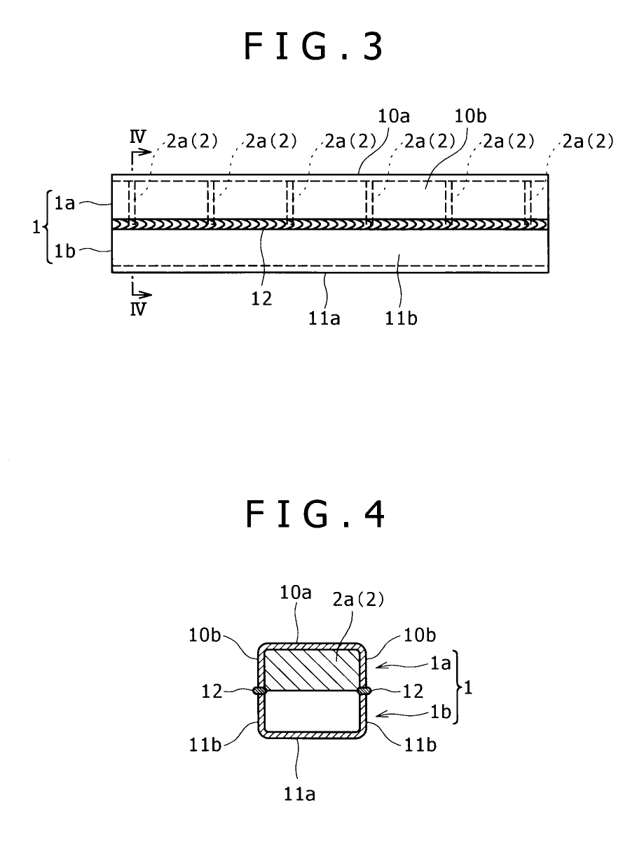

First, referring to FIGS. 1 to 4, there is described a first embodiment of the invention. A frame having closed cross-sections (hereinafter referred to merely as a frame), according to the first embodiment, is made up of a body 1, and an internal reinforcing member 2, as shown in FIGS. 1 to 3.

The body 1 is formed in the shape of a cylinder extending in a predetermined direction, and cross-sections perpendicular to the axial direction thereof are each a closed section substantially rectangular in shape. The body 1 includes a first frame member 1a, and a second frame member 1b. The first frame member 1a, and the second frame member 1b in as-disposed state so as to be opposed to each other are joined together, thereby making up the body 1 in the shape of the cylinder.

More specifically, the first frame member 1a is formed in a shape having open cross-sections that are open in one direction by applying pressing, and so forth to a sheet member made of an aluminum alloy. The first frame member 1a includes a first bottom 10a in the shape of a flat plate, and a pair of first side parts 10b, 10b, vertically erected from respective ends of the first bottom 10a, in the widthwise direction thereof, and disposed so as to be opposed to each other with spacing interposed therebetween.

The second frame member 1b is formed in the same shape as that for the first frame member 1a by applying pressing, and so forth to an aluminum alloy sheet member. That is, the second frame member 1b includes a second bottom 11a in the shape of a flat plate, and a pair of second side parts 11b, 11b, vertically erected from respective ends of the second bottom 11a, in the widthwise direction thereof, and disposed so as to be opposed to each other with spacing interposed therebetween.

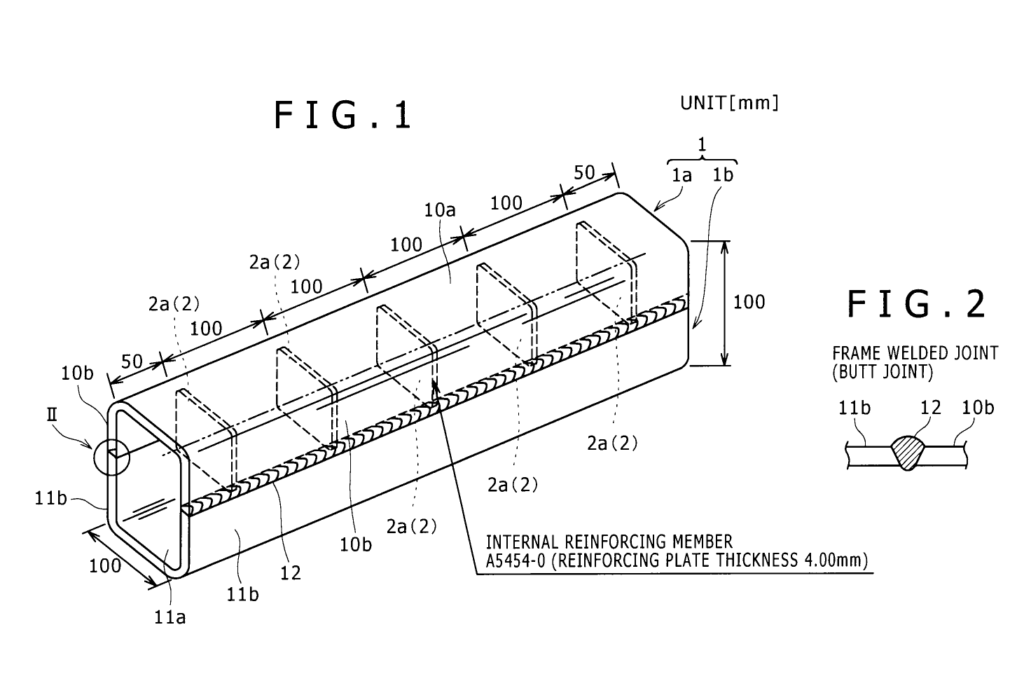

Then, as shown in FIGS. 1, and 2, ends of the respective first side parts 10b of the first frame member 1a, on a side thereof, opposite from the first bottom 10a are joined to corresponding ends of the respective second side parts 11b of the second frame member 1b, on a side thereof, opposite from the second bottom 11a by butt joint, that is, by the MIG (MIG: Metal Inert Gas) welding, and so forth, in a state as-butted against each other. The body 1 in the shape of the cylinder is made up as above, and a welded joint 12 between the first side part 10b, and the second side part 11b is provided along the axial direction of the body 1, at the central part of each of the side parts thereof, in the direction of height,

The internal reinforcing member 2 is installed inside the body 1, and has a function for controlling inward denting of the respective side parts of the body 1, where the welded joint 12 is located. The internal reinforcing member 2 includes plural reinforcing plates 2a. The reinforcing plate 2a is a sheet material formed into a substantially rectangular shape. The reinforcing plates 2a are disposed orthogonally to the axial direction of the body 1, and at equal intervals in the axial direction of the body 1.

Further, as is evident from FIG. 4, the reinforcing plates 2a are disposed only in space surrounded by the first frame member 1a. Respective end faces of the reinforcing plate 2a, in the widthwise direction of the body 1, are butted against respective inner side faces of the first side parts 10b, corresponding thereto. Further, one end face (the upper end face in FIG. 4) of the reinforcing plate 2a, in the direction of height, orthogonal to the widthwise direction of the body 1, is butted against an inner side face of the first bottom 10a. Those constituent members of respective butted portions, at least one location, are secured (joined) together by welding. Meanwhile, the other end face (the lower end face in FIG. 4) of the reinforcing plate 2a, in the direction of height, is disposed so as to be isolated from the second side parts 11b.

Herein, a term “butted against” means that two members are in contact with each other, including both the case of two members securely held by welding, and so forth, and the case of two members being simply in contact with each other. Further, a term “joined” means that the two members in contact with each other are securely held by welding, and so forth. In description of the following embodiments and working examples, these terms will be differentially used as above.

Next, there is described operation of the frame according to the first embodiment, made up as described in the foregoing. When an external force is applied in the longitudinal direction (the axial direction) of the frame upon collision with a vehicle, and so forth, the frame is collapsed in the axial direction thereof, thereby absorbing energy generated by the external force. Since compressive strength of the frame, in a direction in which a pair of the welded joints 12 are aligned with each other, is rendered higher than compressive strength in any direction orthogonal thereto by the action of the internal reinforcing member 2 (the reinforcing plates 2a) provided in the body 1 as described above, at this point in time, the respective side parts of the body 1, where the welded joint 12 is located, are prevented from undergoing deformation in such a way as to be inwardly dented. Hence, the respective welded joints 12 are prevented from being opened, and undergoing rupture. Accordingly, with the frame according to the first embodiment, it is possible to prevent the respective welded joints 12 from being turned into a wide-open state, or being broken when an external force is applied to the frame upon collision with a vehicle, and so forth, causing the frame to be collapsed.

### Second Embodiment

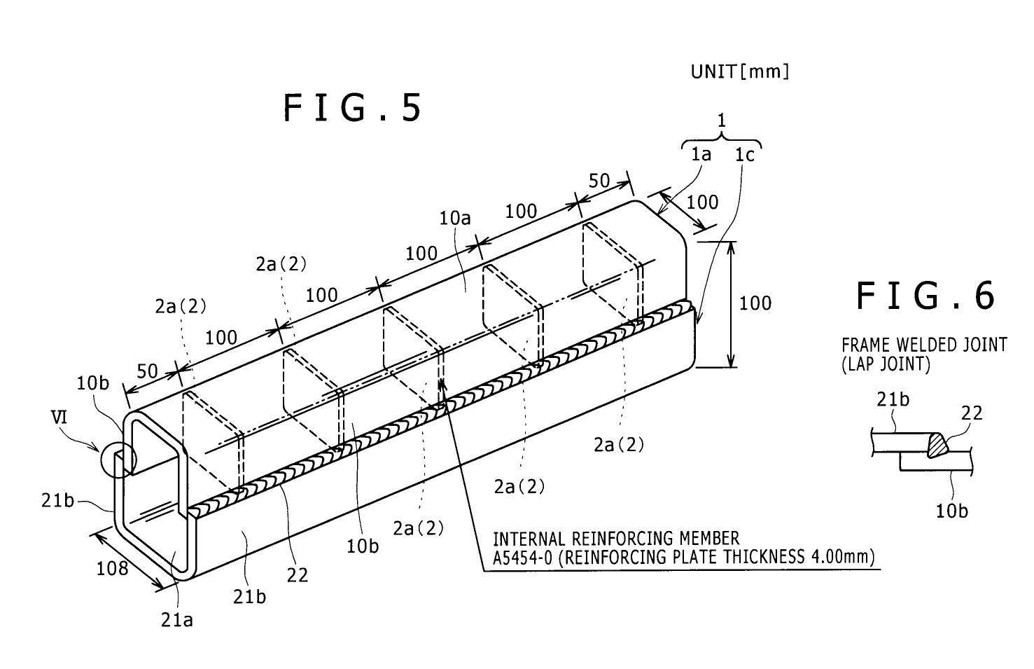

Referring to FIGS. 5 to 8, there is described hereinafter a second embodiment of the invention. In FIGS. 5 to 8, constituents identical to those in FIGS. 1 to 4 are denoted by like reference numerals, thereby omitting detailed description thereof.

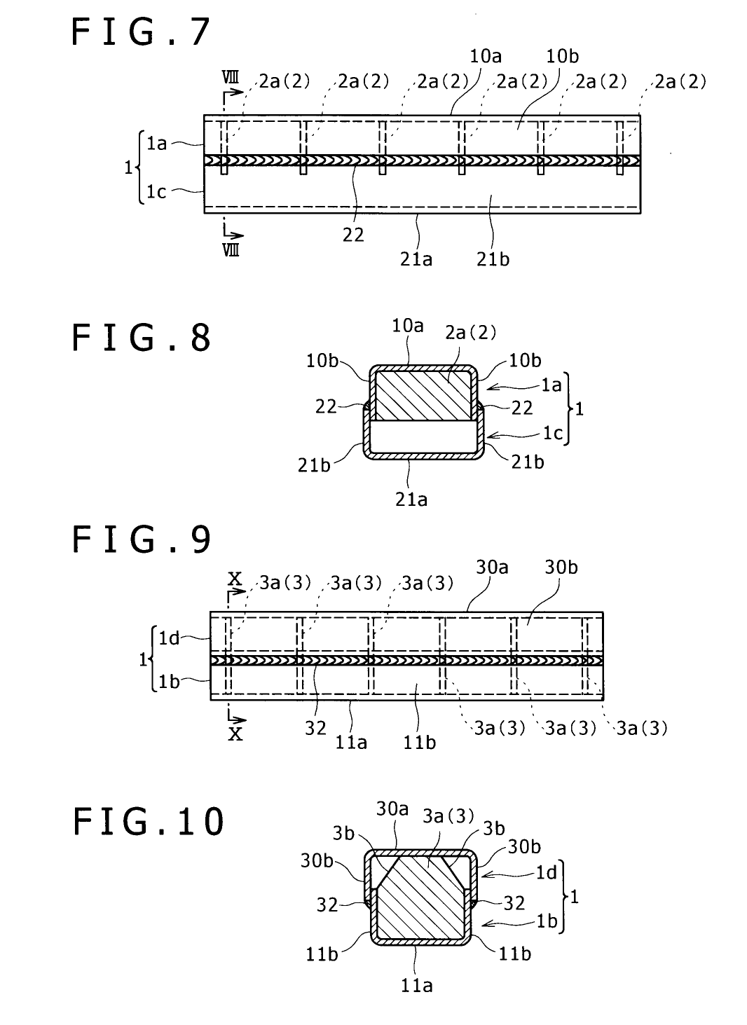

A frame according to the second embodiment is made up of a body 1, and an internal reinforcing member 2, as shown in FIGS. 5 and 7.

The body 1 is formed in the shape of a cylinder extending in a predetermined direction, and cross-sections perpendicular to the axial direction thereof are each a closed section substantially rectangular in shape. The body 1 includes a first frame member 1a, and a second frame member 1c. The second frame member 1c is substantially the same in configuration as the second frame member 1b according the first embodiment. That is, the second frame member 1c includes a second bottom 21a in the shape of a flat plate, and a pair of second side parts 21b, 21b, vertically erected from respective ends of the second bottom 21a, in the widthwise direction thereof, and disposed so as to be opposed to each other with spacing interposed therebetween. However, the second frame member 1c has a width slightly larger than the width of the second frame member 1b according the first embodiment.

More specifically, as shown in FIG. 8, the second bottom 21a of the second frame member 1c has a width larger than the width of the first bottom 10a of the first frame member 1a, and an interval between the inner side faces of the second side parts 21b, 21b, respectively, of the second frame member 1c is equal to an interval between the outer side faces of the first side parts 10b, 10b, respectively, of the first frame member 1a. Then, as shown in FIGS. 5 and 6, respective ends of the first side parts 10b of the first frame member 1a, on a side thereof, opposite from the first bottom 10a, is joined to respective ends of the second side parts 21b of the second frame member 1c, on a side thereof, opposite from the second bottom 21a, with a lap joint. More specifically, the end of the second side part 21b, on a side thereof, opposite from the second bottom 21a, in a state of overlapping the outer side of the end of the first side part 10b, on a side thereof, opposite from the first bottom 10a, is fillet-welded to an outer side face of the first side part 10b by the MIG welding, and so forth. The second embodiment differs from the first embodiment only in that a welded joint 22 between the first side part 10b of the first frame member 1a, and the second side part 11b of the second frame member 1c is a lap joint, and otherwise, the second embodiment is the same in configuration as the first embodiment.

Next, there is described operation of the frame according to the second embodiment, made up as described in the foregoing. As is the case with the operation of the frame according to the first embodiment, when an external force is applied in the longitudinal direction (the axial direction) of the frame according to the second embodiment, upon collision with a vehicle, and so forth, the frame is collapsed in the axial direction thereof, thereby absorbing energy generated by the external force. Then, the welded joint 22 is prevented from being turned in a wide open state, or being broken at this point in time due to the same action and effect of the frame as those described in the case of the first embodiment.

### Third Embodiment

Referring to FIGS. 9 to 12, there is described hereinafter a third embodiment of the invention. In FIGS. 9 to 12, constituents identical to those in FIGS. 1 to 8 are denoted by like reference numerals, thereby omitting detailed description thereof.

A frame according to the third embodiment is made up of a body 1, and an internal reinforcing member 3, as shown in FIGS. 9 and 10.

The body 1 is formed in the shape of a cylinder extending in a predetermined direction, and cross-sections perpendicular to the axial direction thereof are each a closed section substantially rectangular in shape. The body 1 includes a first frame member 1d, and a second frame member 1. The first frame member 1 is substantially the same in configuration as the first frame member 1a according the first embodiment. That is, the first frame member 1d includes a first bottom 30a in the shape of a flat plate, and a pair of first side parts 30b, 30b, vertically erected from respective ends of the first bottom 30a, in the widthwise direction thereof, and disposed so as to be opposed to each other with spacing interposed therebetween. However, the first frame member 1d has a width slightly larger than the width of the first frame member 1a according the first embodiment.

More specifically, as shown in FIG. 10, the first bottom 30a of the first frame member 1d has a width larger than the width of a second bottom 11a of the second frame member 1b, and an interval between the inner side faces of the first side parts 30b, 30b, respectively, of the first frame member 1d is equal to an interval between the outer side faces of the second side parts 11b, 11b, respectively, of the second frame member 1b. Then, an end of the first side parts 30b of the first frame member 1d, on a side thereof, opposite from the first bottom 30a, is joined to an end of the second side part 11b of the second frame member 1b, on a side thereof, opposite from a second bottom 11a, with a lap joint. More specifically, the end of the first side part 30b, on a side thereof, opposite from the first bottom 30a, in a state of overlapping the outer side of the end of the second side part 11b, on a side thereof, opposite from the second bottom 11a, is fillet-welded to an outer side face of the second side part 11b by the MIG welding, and so forth.

The internal reinforcing member 3 has the same function as that of the internal reinforcing member according to the first embodiment, and is made up of plural reinforcing plates 3a. The reinforcing plates 3a each are disposed inside the body 1 so as to be orthogonal to the axial direction of the body 1, and at equal intervals in the axial direction of the body 1. Further, the reinforcing plate 3a is equal in dimension to an interval between the inner side faces of the second side parts 11b, 11b, respectively, in the widthwise direction of the body 1. Furthermore, the reinforcing plate 3a is equal in dimension to an interval between the inner side faces of the first bottom 30a, and the second bottom 11a, in the direction of height, orthogonal to the widthwise direction of the body 1.

With the third embodiment of the invention, respective end faces of the reinforcing plate 3a, in the widthwise direction of the body 1, have a portion butted against the inner side face of the second side part 11b, corresponding thereto, and a portion disposed so as to be isolated from the inner side face of the first side part 30b, corresponding thereto. More specifically, the portion disposed so as to be isolated from the inner side face of the first side part 30b is linked with an upper side part of the portion butted against the inner side face of the second side part 11b, in FIG. 10. Further, the portion disposed so as to be isolated from the inner side face of the first side part 30b constitutes a tilted part 3b inwardly tilting toward an upper side in FIG. 10. One end face (the upper end face in FIG. 10) of the reinforcing plate 3a, in the direction of height, orthogonal to the widthwise direction of the body 1, is butted against the inner side face of the first bottom 30a while the other end face (the lower end face in FIG. 10) thereof is butted against the inner side face of the second bottom 11a. By so doing, rigidity of the frame, in the direction of the height, is enhanced.

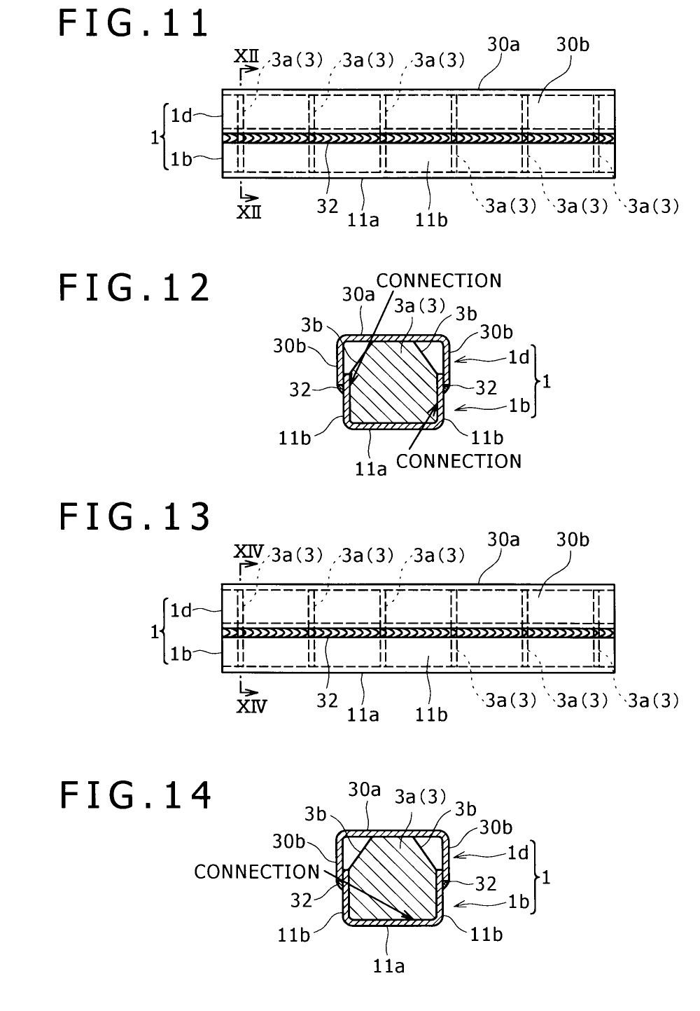

With the frame according to the third embodiment of the invention, if the reinforcing plate 3a, and respective inner side faces of the second frame member 1b, at least one location of butted portions therebetween, are secured (joined) together by welding as shown in FIGS. 9, and 10, this will suffice. Otherwise, as in the case of the embodiment shown in FIGS. 11, and 12, the reinforcing plate 3a, and the second frame member 1b may be joined together only at the respective inner side faces of the second side parts 11b, 11b while the reinforcing plate 3a, and the second frame member 1b may be simply in contact with each other at the inner side face of the second bottom 11a.

Further, the reinforcing plate 3a is designed such that a difference between a dimension of the reinforcing plate 3a, in the direction of the height, and a distance from the inner side face of the second bottom 11a of the second frame member 1b to an edge of the second side part 11b, on a side thereof, opposite from the second bottom 11a is equal to a distance from the edge of the second side part 11b, on the side thereof, opposite from the second bottom 11a to the inner side face of the first bottom 30a of the first frame member 1d. Accordingly, the one end face of the reinforcing plate 3a, in the direction of the height, is butted against the inner side face of the first bottom 30a as described in the foregoing. A butted portion between the reinforcing plate 3a, and the first bottom 30a may be either securely held by welding, or may not be securely held.

With the third embodiment, the end of the first side part 30b, on the side thereof, opposite from the first bottom 30a, in the state of overlapping the outer side of the end of the second side part 11b, on the side thereof, opposite from the second bottom 11a, is fillet-welded to the outer side face of the second side part 11b by the MIG welding, and so forth. In this case, an overlapping length between the end of the first side part 30b, and the end of the second side part 11b is dependent on the dimension of the reinforcing plate 3a, in the direction of the height.

In the case of executing welding by use of the lap joint as described in the foregoing, it is relatively difficult to accurately execute positioning of the first frame member 1d in relation to the second frame member 1b such that the overlapping length between the end of the first side part 30b, and the end of the second side part 11b will be an overlapping length as desired. With the third embodiment, however, since the one end face of the reinforcing plate 3a, in the direction of the height, is butted against the inner side face of the first bottom 30a while the other end face thereof is butted against the inner side face of the second bottom 11a, the positioning described as above can be executed with ease. That is, the internal reinforcing member 3 (the reinforcing plates 3a) is provided with a function for reinforcing the frame in combination with a function for executing positioning of a welded joint 32 between the first frame member 1d and the second frame member 1b.

Next, there is described operation of the frame according to the third embodiment, made up as described in the foregoing. As is the case with the operation of the frame according to the first and second embodiments, respectively, when an external force is applied in the longitudinal direction (the axial direction) of the frame according to the third embodiment, upon collision with a vehicle, and so forth, the frame is collapsed in the axial direction thereof, thereby absorbing energy generated by the external force. At this point in time, the reinforcing plate 3a as well undergoes deformation to some extent, thereby contributing to absorption of the energy generated by the external force. Then, in contrast with the respective cases of the first and second embodiments, the reinforcing plate 3a according to the third embodiment is butted against both the first frame member 1d, and the second frame member 1b, so that energy transferred from the respective frame members is absorbed to a degree by the reinforcing plate 3a. Accordingly, with the reinforcing plate 3a according to the third embodiment, absorption performance against the energy generated by the external force is enhanced as compared with the reinforcing plate 2a that is butted against the first frame member 1a only, as in the respective cases of the first and second embodiments. Further, since compressive strength the frame, in a direction in which a pair of the welded joints 32, 32 are aligned with each other, is rendered higher than compressive strength in any direction orthogonal thereto by the action of the internal reinforcing member 3 (the reinforcing plates 3a) provided in the body 1 as described in the foregoing, the respective side parts of the body 1, where the welded joint 32 is located, are prevented from undergoing deformation in such a way as to be inwardly dented. Furthermore, with the third embodiment, the portion of the reinforcing plate 3a, corresponding to the first side part 30b of the first frame member 1d, is provided with the tilted part 3b, so that a portion of the first frame member 1d, corresponding to the tilted part 3b, is not butted against the reinforcing plate 3a. The first frame member 1d is therefore prone to be deformed so as to be collapsed. On the other hand, since the second side part 11b of the second frame member 1b is butted against the reinforcing plate 3a, the second frame member 1b is impervious to deformation. Owing to such a makeup of the frame as described, the portion of the first frame member 1d, corresponding to the tilted part 3b of therein forcing plate 3a, will under go deformation when the external force is applied to the frame, but the welded joint 32 can be prevented from being deformed in such a way as to be inwardly dented. Thus, with the third embodiment, portions of the respective side parts of the body 1, where the welded joint 32 is located, are prevented from undergoing deformation in such a way as to be inwardly dented. Hence, the respective welded joints 32 are prevented from being opened, and undergoing rupture.

### Fourth Embodiment

Referring to FIGS. 13, 14, there is described hereinafter a fourth embodiment of the invention. In FIGS. 13, 14, constituents identical to those in FIGS. 1 to 12 are denoted by like reference numerals, thereby omitting detailed description thereof.

The fourth embodiment differs from the third embodiment in that the reinforcing plate 3a, and the second frame member 1b are joined together only at the other end face (the bottom face), in the direction of the height of the body 1, and the inner side face of the second bottom 11a while, in the case of the third embodiment (the embodiment shown in FIGS. 11, and 12) described as above, the reinforcing plate 3a, and the second frame member 1b are joined together only at the respective inner side faces of the second side parts 11b, 11b, corresponding to the respective side faces of the reinforcing plate 3a. Otherwise, a frame according to the fourth embodiment is the same in structure as the frame according to the third embodiment.

With the frame according to the fourth embodiment, the reinforcing plate 3a is joined to the second frame member 1b only at the bottom face thereof, but is not joined to the second frame member 1b at the side faces thereof, so that at a time when the frame is collapsed in the axial direction thereof to thereby absorb energy generated by the external force, an absorption form is urged such that the respective side parts of the body 1 undergo deformation in a state of outward protrusion. As a result, the respective welded joints 32 are prevented from being open, and undergoing rupture.

Otherwise, the frame according to the fourth embodiment has the same effects as those obtained in the case of the frame according to the third embodiment.

### Fifth Embodiment

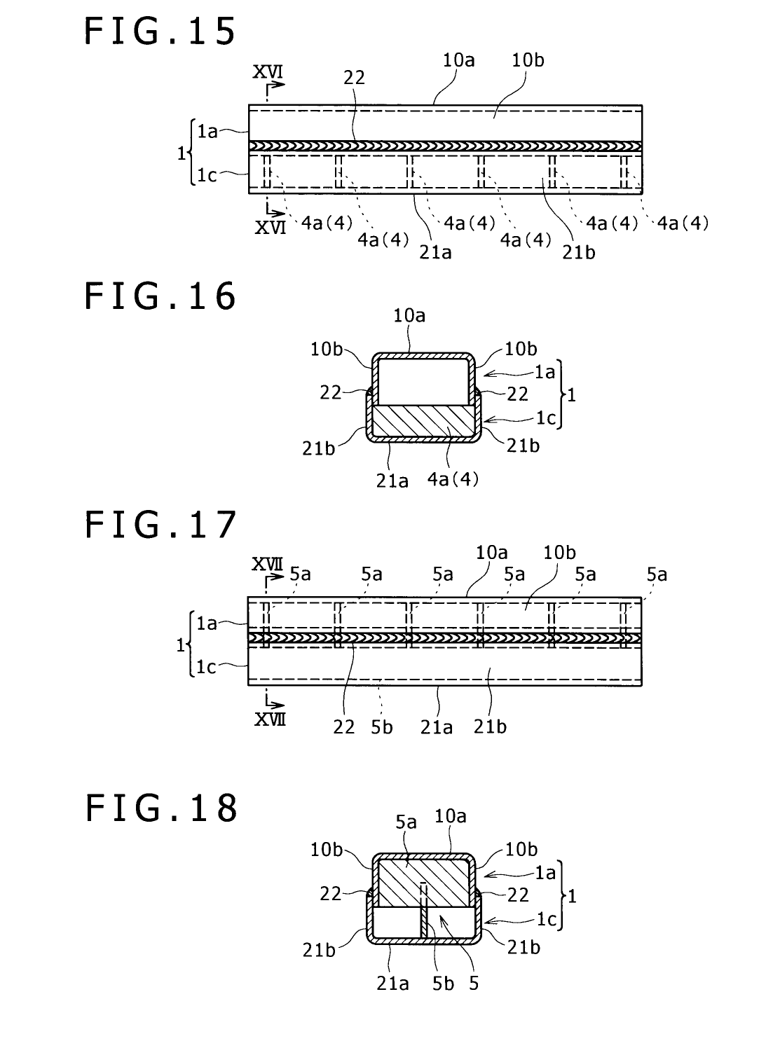

Referring to FIGS. 15, 16, there is described hereinafter a fifth embodiment of the invention. In FIGS. 15, 16, constituents identical to those in FIGS. 1 to 14 are denoted by like reference numerals, thereby omitting detailed description thereof.

A frame according to the fifth embodiment is made up of a body 1, and an internal reinforcing member 4, as shown in FIGS. 15 and 16.

The body 1 is the same in makeup as the body 1 according to the second embodiment described as above, including a first frame member 1a, and a second frame member 1c, welded together by lap joint.

The internal reinforcing member 4 includes plural reinforcing plates 4a, each being formed in a substantially rectangular shape. The reinforcing plates 4a are disposed orthogonally to the axial direction of the body 1, and at equal intervals in the axial direction of the body 1. The reinforcing plates 4a each have a width equal to an interval between the outer side faces of the first side parts 10b, 10b, respectively, of the first frame member 1a, in other word, an interval between the inner side faces of the second side parts 21b, 21b, respectively, of the second frame member 1c. Further, the respective reinforcing plates 4a are disposed only in space surrounded by the second frame member 1c within space inside the body 1. Respective end faces of the reinforcing plate 4a, in the widthwise direction of the body 1, are butted against respective inner side faces of the second side parts 21b, corresponding thereto. Further, one end face (the upper end face in FIG. 16) of the reinforcing plate 4a, in the direction of height, orthogonal to the widthwise direction of the body 1, is butted against respective end faces of the first side parts 10b of the first frame member 1a, on a side thereof, opposite from the first bottom 10a. At least one location of respective butted portions of the reinforcing plate 4a, and the inner side faces of the second frame member 1c is secured (joined) by welding.

Since the one end face of the reinforcing plate 4a is butted against the respective end faces of the first side parts 10b of the first frame member 1a, on the side thereof, opposite from the first bottom 10a, the reinforcing plate 4a is provided with a function for reinforcing the frame in combination with a function for executing positioning of the first frame member 1a, the second frame member 1c, and welded joints 22, respectively. More specifically, at the time of manufacturing the frame, the respective reinforcing plate 4a are attached to the inner side of the second frame member 1c, and the first frame member 1a is subsequently disposed so as to oppose the second frame member 1c. At this point in time, the respective end faces of both the first side parts 10b, 10b of the first frame member 1a, on the side thereof, opposite from the first bottom 10a, are inserted between the respective ends of the second side parts 21b, 21b of the second frame member 1c, on the side thereof, opposite from the second bottom 21a. In so doing, the respective end faces of the first side parts 10b, 10b of the first frame member 1a, on the side thereof, opposite from the first bottom 10a, are butted against the upper end face (in FIG. 16) of the reinforcing plate 4a. In this case, an overlapping length between each of the ends of the first side parts 10b, 10b, respectively, of the first frame member 1a, on the side thereof, opposite from the first bottom 10a, and each of the ends of the second side parts 21b, 21b, respectively, of the second frame member 1c, on the side thereof, opposite from the second bottom 21a is dependent on a dimension of the reinforcing plate 4a, in the direction of the height. Thus, with the fifth embodiment, the positioning of the first frame member 1a, in relation to the second frame member 1c, can be easily implemented by the function of the reinforcing plate 4a such that the overlapping length between the first side part 10b, and the second side part 21b will be an overlapping length as desired. Then, the respective ends of the second side parts 21b, 21b, on the side thereof, opposite from the second bottom 21a, in a state of overlapping, are fillet-welded to the respective outer side faces of the first side parts 10b, 10b by the MIG welding, and so forth. The frame according to the fifth embodiment is formed in this way.

The frame according to the fifth embodiment is the same in its action and effects as the frame according to the second embodiment described in the foregoing.

### Sixth Embodiment

Referring to FIGS. 17 to 19, there is described hereinafter a sixth embodiment of the invention. In FIGS. 17, 18, constituents identical to those in FIGS. 1 to 16 are denoted by like reference numerals, thereby omitting detailed description thereof.

A frame according to the sixth embodiment is made up of a body 1, and an internal reinforcing member 5, as shown in FIGS. 17 and 18.

The body 1 is the same in makeup as the body 1 according to the second and fifth embodiments, respectively, described as above, including a first frame member 1a, and a second frame member 1c, welded together by lap joint.

With the sixth embodiment, the internal reinforcing member 5 includes plural reinforcing plates 5a, and an axial direction member 5b.

The plural the reinforcing plates 5a are attached to the axial direction member 5b. The reinforcing plates 5a each are formed in a shape substantially rectangular to be disposed orthogonally to the axial direction of the body 1, and at equal intervals in the axial direction of the body 1. Respective end faces of the reinforcing plate 2a, in the widthwise direction of the body 1, are butted against respective inner side faces of the first side parts 1b, corresponding thereto. Further, an end face (the upper end face in FIG. 18) of each of the reinforcing plates 5a, positioned on one side, in the direction of the height of the body 1, is butted against the inner side face of a first bottom 10a.

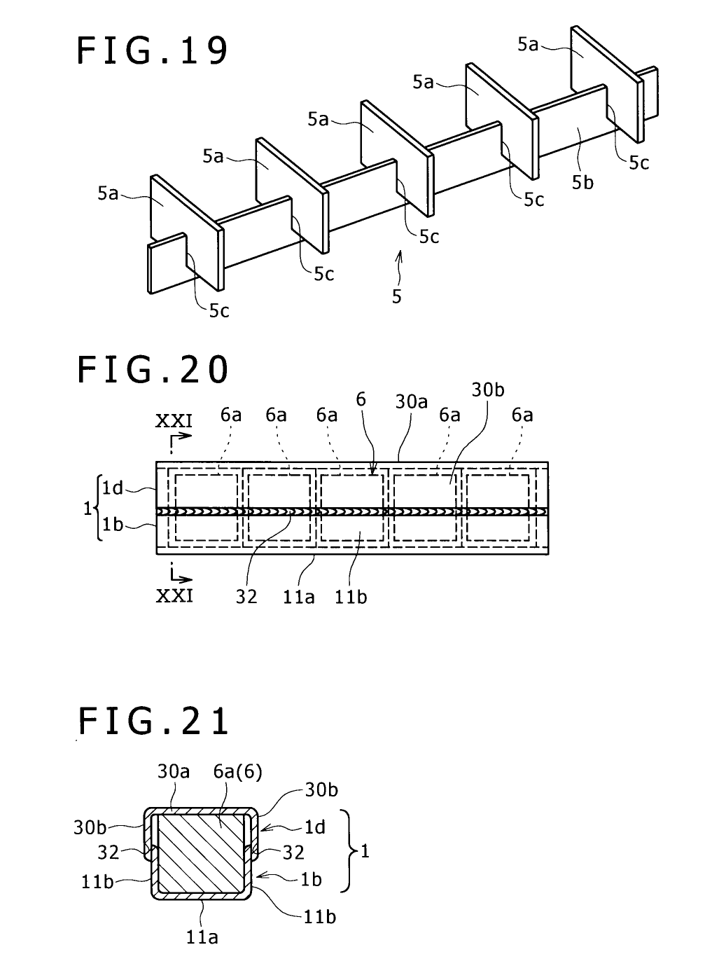

The axial direction member 5b is extended in the axial direction of the body 1, and is made up of a sheet member erected on an inner side face of a second bottom 21a of the second frame member 1c. More specifically, an end face (the lower end face in FIG. 18) of the axial direction member 5b, positioned on the other side, in the direction of the height of the body 1, is butted against the inner side face of the second bottom 21a. Further, the axial direction member 5b has a length equal to a dimension of the second frame member 1c, in the axial direction thereof. Then, rigidity (strength) of the frame, in the axial direction thereof, is enhanced by virtue of the axial direction member 5b. The axial direction member 5b has plural incisions 5c provided at equal intervals in the axial direction of the body 1, as shown in FIG. 19, by machining, and so forth. The respective incisions 5c are disposed so as to be vertical to the axial direction of the body 1, and are formed to a predetermined depth from an upper end face of the axial direction member 5b, in FIG. 19. Further, each of the reinforcing plates 5a is inserted into the respective incisions 5c.

Then, upon the upper end face (in FIG. 18) of the reinforcing plate 5a being butted against the inner side face of the first bottom 10a, the lower end face (in FIG. 18) of the axial direction member 5b is butted against the inner side face of the second bottom 21a, so that, as is with the case of the internal reinforcing member 3 (the reinforcing plates 3a) according to the third embodiment, the internal reinforcing member 5 is provided with a function for reinforcing the frame in combination with a function for executing positioning of a welded joint 22, that is, positioning of the first frame member 1a in relation to the second frame member 1c such that an overlapping length between the first side part 10b, and the second side part 21b will be an overlapping length as desired.

Further, as the internal reinforcing member 5 is self-supporting on its own, the internal reinforcing member 5 is disposed inside the second frame member 1c at the time of manufacturing the frame without particularly welding the internal reinforcing member 5 with the first frame member 1a, and the second frame member 1c, respectively. In this state, the first frame member 1a is disposed so as to oppose the second frame member 1c. Thereafter, with the first side part 10b of the first frame member 1a, and the second side part 21b of the second frame member 1c, keeping an overlapping length dependent on a height of the internal reinforcing member 5, the MIG welding is applied to the respective welded joints 22 of both the frame members in such a way as to form a lap joint. Thus, the frame according to the sixth embodiment, incorporating the internal reinforcing member 5, is formed.

Next, there is described operation of the frame according to the sixth embodiment, made up as described in the foregoing. As is the case with the operation of the frame according to the first to fifth embodiments, respectively, when an external force is applied in the longitudinal direction (the axial direction) of the frame according to the sixth embodiment, upon collision with a vehicle, and so forth, the frame is collapsed in the axial direction thereof, thereby absorbing the energy generated by the external force. In contrast to the first and second embodiments, with the sixth embodiment, at this point in time, the internal reinforcing member 5 is butted against both the first frame member 1a, and the second frame member 1c, so that absorption performance against the energy generated by the external force is enhanced. Further, the rigidity (strength) of the frame, in the axial direction thereof, is enhanced by virtue of the axial direction member 5b of the internal reinforcing member 5, however, since the axial direction member 5b is provided with the plural the incisions 5c along the axial direction of the body 1, compressive strength of the frame, in the axial direction thereof, is prevented from becoming excessively high. In consequence, compressive strength of the frame, in a direction in which a pair of the welded joints 22, 22 are aligned with each other is rendered relatively high as compared with the compressive strength of the frame, in the axial direction thereof. Hence, the respective side parts of the body 1, where the welded joint 22 is located, are prevented from undergoing deformation in such away as to be inwardly dented. As a result, the respective welded joints 22 are prevented from being opened, and undergoing rupture.

### Seventh Embodiment

Referring to FIGS. 20 to 21, there is described hereinafter a seventh embodiment of the invention. In FIGS. 20, 21, constituents identical to those in FIGS. 1 to 19 are denoted by like reference numerals, thereby omitting detailed description thereof.

A frame according to the seventh embodiment is made up of a body 1, and an internal reinforcing member 6, as shown in FIGS. 20, and 21.

The body 1 is the same in makeup as the body 1 according to the third and fourth embodiments, respectively, described as above, including a first frame member 1d, and a second frame member 1b, welded together by lap joint.

With the seventh embodiment, the internal reinforcing member 6 is made up of plural extruded shapes 6a.

The extruded shape 6a is formed by cutting a extruded shape in the shape of a square cylinder, one side thereof being equal in dimension to an interval between the inner side faces of second side parts 11b, 11b, respectively, to a predetermined dimension shorter than a dimension thereof, in the longitudinal direction of the second frame member 1b. Further, the plural the extruded shapes 6a are arrayed and are disposed such that the axial directions of the respective extruded shapes 6a are oriented toward a direction orthogonal to an array direction of the extruded shapes 6a, and in the same direction. The extruded shapes 6a adjacent to each other are joined with each other by welding and so forth, thereby forming the internal reinforcing member 6. Further, the internal reinforcing member 6 is disposed inside the body 1 such that the axial directions of the respective extruded shapes 6a coincide with a direction in which a pair of the welded joints 22, 22 of the body 1 are aligned with each other. By so doing, rigidity (strength) of the frame, in the axial direction thereof, is enhanced. Furthermore, since the respective extruded shapes 6a that are formed after cutting a long extruded shape are simply joined together by welding and so forth, thereby forming the internal reinforcing member 6, a processing cost is quite low as compared with an internal reinforcing member fabricated by forming the incisions 5c by machining as in the case of the internal reinforcing member 5 according to the sixth embodiment. Further, the respective extruded shapes 6a are sufficiently joined with each other by tack welding, or the like since a high bonding strength is not required.

Further, at the time of fabricating the frame, with the internal reinforcing member 6 kept in such a state as disposed inside the second frame member 1b, the first frame member 1d is disposed so as to oppose the second frame member 1b. Thereafter, with the first side part 30b of the first frame member 1d, and the second side part 11b of the second frame member 1b, keeping an overlapping length dependent on a height of the internal reinforcing member 6, the MIG welding is applied to the respective welded joints 32 of both the frame members such that a lap joint is formed. Thus, the frame according to the sixth embodiment, incorporating the internal reinforcing member 6, is formed.

Next, there is described operation of the frame according to the seventh embodiment, made up as described in the foregoing. As is the case with the operation of the frame according to the first to sixth embodiments, respectively, when an external force is applied in the longitudinal direction (the axial direction) of the frame according to the seventh embodiment, upon collision with a vehicle, and so forth, the frame is collapsed in the axial direction thereof, thereby absorbing the energy generated by the external force. In contrast to the first and second embodiments, with the seventh embodiment, the internal reinforcing member 6 is butted against both the first frame member 1d, and the second frame member 1b at this point in time, so that absorption performance against the energy generated by the external force is enhanced. Furthermore, since the internal reinforcing member 6 is disposed inside the body 1 such that the axial directions of the respective extruded shapes 6a coincide with the direction in which the pair of the welded joints 22, 22 of the body 1 are aligned with each other, compressive strength of the frame, in the direction in which the pair of the welded joints 32 are aligned with each other, is higher than compressive strength in any direction orthogonal thereto. Hence, the respective side parts of the body 1, where the welded joint 32 is located, are prevented from undergoing deformation in such a way as to be inwardly dented. As a result, the respective welded joints 32 are prevented from being open, and undergoing rupture.

### Working Examples

There are described hereinafter working examples for demonstrating the effects of the invention. The frame according to the first embodiment, shown in FIG. 1, was fabricated as Working Example 1. The first frame member 1a, and the second frame member 1b were formed by applying pressing, and so forth to an A5454 P-O aluminum alloy sheet member 4 mm in sheet thickness, so as to have open cross-sections. The first frame member 1a, and the second frame member 1b each had a dimension 500 mm in the longitudinal direction thereof. The first bottom 10a and the second bottom 11a each had a dimension between outer side faces thereof, in the crosswise direction thereof, at 100 mm.

Similarly, by forming an A5454 P-O aluminum alloy sheet member 4 mm in sheet thickness into a rectangular shape, the reinforcing plate 2a was fabricated. The reinforcing plate 2a was disposed at a site 50 m away from an end of the first frame member 1a, in the longitudinal direction thereof, so as to be butted against respective inner side faces of the first frame member 1a, and starting from the site, the reinforcing plates 2a were disposed at equal intervals of 100 mm, along the longitudinal direction of the first frame member 1a, whereupon respective end faces of each of the reinforcing plates 2a were joined to respective inner side faces of the first frame member 1a by the MIG welding.

Thereafter, the MIG welding was applied to the first frame member 1a, and the second frame member 1b, in such a state as opposed to each other, such that welded joints 12 each become a butt joint. By so doing, the frame 100 mm in height was fabricated. The MIG welding was applied with a common MIG welder using an A4043WY welding wire 1.2 mm in diameter.

Thus, there was fabricated the frame according to Working Example 1, 100 mm high, 100 mm wide, and 500 mm long, wherein 5 pieces of the reinforcing plates 2a were disposed at intervals of 100 mm inside the first frame member 1a, and the butt joints were provided.

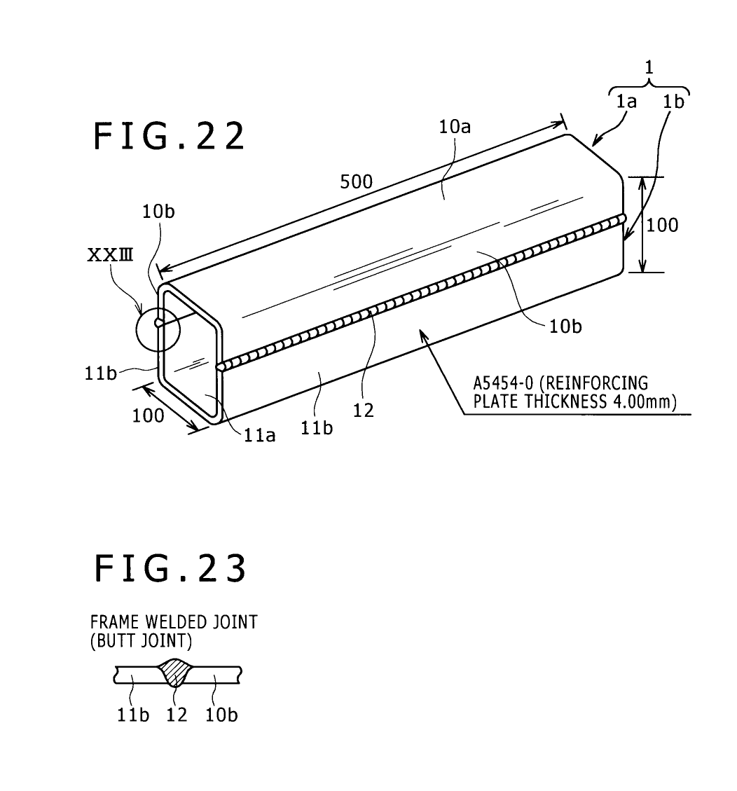

Furthermore, as Comparative Example 1, there was fabricated a frame equivalent to Working Example 1 described as above except that the reinforcing plate 2a was not disposed inside the first frame member 1a, as shown FIGS. 22, and 23, that is, the frame 500 mm in length, provided with closed cross-sections each 100 mm×100 mm, and butt joints. In FIGS. 22, and 23, constituents identical to those in FIGS. 1 to 21 are denoted by like reference numerals, thereby omitting detailed description thereof.

Further, the frame according to the second embodiment, as shown in FIG. 5, was fabricated as Working Example 2 of the invention. The first frame member 1a, and the second frame member 1c were formed by applying pressing, and so forth to an A5454 P-O aluminum alloy sheet member 4 mm in sheet thickness, so as to have open cross-sections. The first frame member 1a, and the second frame member 1c each had a dimension 500 mm in the longitudinal direction thereof. The first bottom 10a of the first frame member 1a had a dimension 100 mm between outer side faces of the first bottom 10a, in the crosswise direction thereof, and the second bottom 21a of the second frame member 1c had a dimension 108 mm between outer side faces of the second bottom 21a, in the crosswise direction thereof.

Similarly, by forming an A5454 P-O aluminum alloy sheet member 4 mm in sheet thickness into a rectangular shape, a reinforcing plate 2a was fabricated. The reinforcing plate 2a was disposed at a site 50 mm away from an end of the first frame member 1a, in the longitudinal direction thereof, so as to be butted against respective inner side faces of the first frame member 1a, and starting from the site, the reinforcing plates 2a were disposed at equal intervals of 100 mm, along the longitudinal direction of the first frame member 1a, whereupon respective end faces of each of the reinforcing plates 2a were joined to respective inner side faces of the first frame member 1a by the MIG welding.

Thereafter, the MIG welding was applied to the first frame member 1a, and the second frame member 1c, in a state where the first side part 10b of the first frame member 1a, and the second side part 21b of the second frame member 1c, overlapping with each other, such that welded joints 22 each become the lap joint. By so doing, the frame 100 mm in height was fabricated. The MIG welding was applied with the common MIG welder using the A4043WY welding wire 1.2 mm in diameter.

Thus, there was fabricated a frame according to Working Example 2, 100 mm high, 108 mm in larger width, 100 mm in smaller width, and 500 mm long, wherein 5 pieces of the reinforcing plates 2a were disposed at intervals of 100 mm inside the first frame member 1a, and the lap joints were provided.

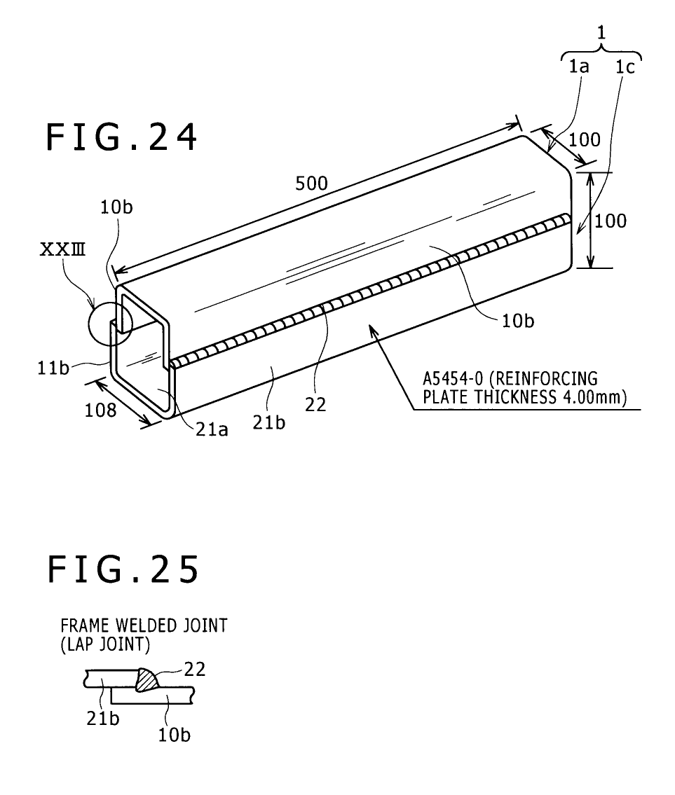

Furthermore, as Comparative Example 2, there was fabricated a frame equivalent to Working Example 2 described as above except that the reinforcing plate 2a was not disposed inside the first frame member 1a, as shown FIGS. 24, and 25. In FIGS. 24, and 25, constituents identical to those in FIGS. 1 to 23 are denoted by like reference numerals, thereby omitting detailed description thereof.

Further, the frame according to the third embodiment, shown in FIGS. 11, and 12, was fabricated as Working Example 3 of the invention. For the first frame member 1d, the second frame member 1b, and the reinforcing plate 3a, use was made of an A5454 P-O aluminum alloy sheet member 4 mm in sheet thickness, as with the cases of Working Examples 1, and 2, respectively. As shown in FIG. 12, the reinforcing plate 3a, and the second frame member 1b was joined together only at the respective inner side faces of the second side parts 11b, 11b, in pairs, by the MIG welding. Further, with the first side part 30b of the first frame member 1d, and the second side part 11b of the second frame member 1b, in a state having the overlapping length that is dependent on the dimension of the reinforcing plate 3a, in the direction of the height thereof, the MIG welding was executed such that the respective welded joints 32, 32 of both the frame members become a lap joint. By so doing, the frame 100 mm in height was fabricated. The MIG welding was applied with the common MIG welder using the A4043WY welding wire 1.2 mm in diameter.

Further, the frame according to the fourth embodiment, shown in FIGS. 13, and 14, was fabricated as Working Example 4 of the invention. A frame according to Working Example 4 differs from the frame according to Working Example 3 in that the reinforcing plate 3a, and the second frame member 1b are joined together only at the inner side face of the second bottom 11a, as shown in FIG. 14, in contrast to the frame according to Working Example 3, wherein the reinforcing plate 3a, and the second frame member 1b were joined together only at the respective inner side faces of the second side parts 11b, 11b, by welding, as shown in FIG. 12. The frame according to Working Example 4 was fabricated so as to be otherwise the same in structure as the frame according to Working Example 3.

Further, the frame according to the fifth embodiment, shown in FIGS. 15, and 16, was fabricated as Working Example 5 of the invention. For the first frame member 1a, the second frame member 1c, and the reinforcing plate 4a, use was made of an A5454 P-O aluminum alloy sheet member 4 mm in sheet thickness, as with the cases of Working Examples 1 to 4, respectively. As shown in FIG. 16, the reinforcing plate 4a was disposed such that the respective end faces thereof were butted against the respective inner side faces of the second frame member 1C, and the reinforcing plates 4a were disposed at equal intervals in the longitudinal direction of the second frame member 1c, as shown in FIG. 15. Then, the respective end faces of each of the reinforcing plates 4a were joined to the respective inner side faces of the second frame member 1c by the MIG welding. Further, with the first side part 10b of the first frame member 1a, and the second side part 21b of the second frame member 1c, in a state having the overlapping length that is dependent on the dimension of the reinforcing plate 4a, in the direction of the height thereof, the MIG welding was executed such that the respective welded joints 22 of both the frame members become a lap joint. By so doing, the frame 100 mm in height was fabricated. The MIG welding was applied with the common MIG welder using the A4043WY welding wire 1.2 mm in diameter.

Further, the frame according to the sixth embodiment, shown in FIGS. 17, and 18, was fabricated as Working Example 6 of the invention. For the first frame member 1a, the second frame member 1c, and the internal reinforcing member 5, use was made of an A5454 P-O aluminum alloy sheet member 4 mm in sheet thickness, as with the cases of Working Examples 1 to 5, respectively. The incisions 5c were provided at equal intervals in the axial direction member 5b having the same dimension as the dimension of the second frame member 1c, in the longitudinal direction thereof, by machining, and so forth, and the reinforcing plate 5a was inserted into the respective incisions 5c, thereby forming the axial direction member 5b. Further, as the internal reinforcing member 5 was self-supporting on its own, the internal reinforcing member 5 was disposed inside the second frame member 1c without particularly welding the internal reinforcing member 5 with the first frame member 1a, and the second frame member 1c, respectively. In this state, the first frame member 1a was disposed so as to oppose the second frame member 1c. Thereafter, with the first side part 10b of the first frame member 1a, and the second side part 21b of the second frame member 1c, in a state keeping the overlapping length dependent on the height of the internal reinforcing member 5, the MIG welding was executed such that the respective welded joints 22 of both the members became a lap joint. Thus, the frame 100 mm in height was fabricated. Further, the MIG welding was applied with the common MIG welder using the A4043WY welding wire 1.2 mm in diameter.

Further, the frame according to the seventh embodiment, shown in FIGS. 20, and 21, was fabricated as Working Example 7 of the invention. First, the extruded shape 6a was formed by cutting an extruded shape made of A6063-T5 aluminum alloy, in the shape of the square cylinder, 80 mm in one side, and 2.5 mm in wall thickness, to a length 85 mm. Then, the plural the extruded shapes 6a formed as above were arrayed, and were disposed such that the axial directions of the respective extruded shapes 6a were oriented toward the direction orthogonal to the array direction of the extruded shapes 6a, and the same direction. The extruded shapes 6a adjacent to each other were joined with each other by the MIG welding and so forth, to thereby form the internal reinforcing member 6. Further, with the internal reinforcing member 6 kept in the state as disposed inside the second frame member 1b, the first frame member 1d was disposed so as to oppose the second frame member 1b. Thereafter, with the first side part 30b of the first frame member 1d, and the second side part 11b of the second frame member 1b, keeping the overlapping length dependent on the height of the internal reinforcing member 6, the MIG welding was applied to the respective welded joint 32 of both the frame members such that a lap joint is formed. By doing so, the frame 100 mm in height was formed. The MIG welding was applied with the common MIG welder using the A4043WY welding wire 1.2 mm in diameter.

Evaluation on Working Examples 1 to 7, respectively, and Comparative Examples 1, and 2, respectively, was made by conducting a compression test in the lengthwise direction (the longitudinal direction) of the frame, using a universal testing machine capable of applying a load of 100 tons. The respective frames were compressed by mm at the compression test, and the test was completed upon each of the frames being reduced to 400 mm in total length. Thereafter, a ruptured state of each of the frames was observed.

As a result, it was found that with the frames according to Comparative Examples 1, and 2, respectively, that is, with the frames wherein the reinforcing plate 2a was not disposed, the welded joint 12 (22) underwent deformation in such a way as to be inwardly dented, whereupon the welded joint 12 (22) was ruptured and opened.

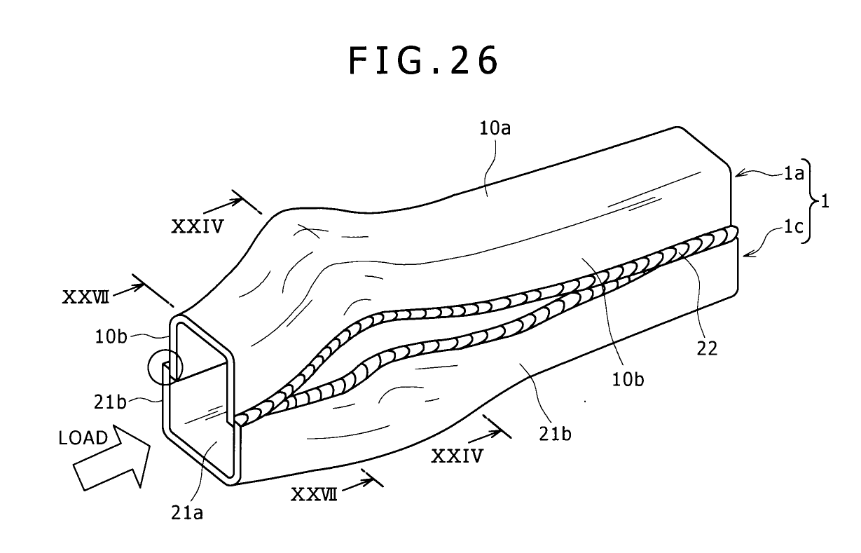

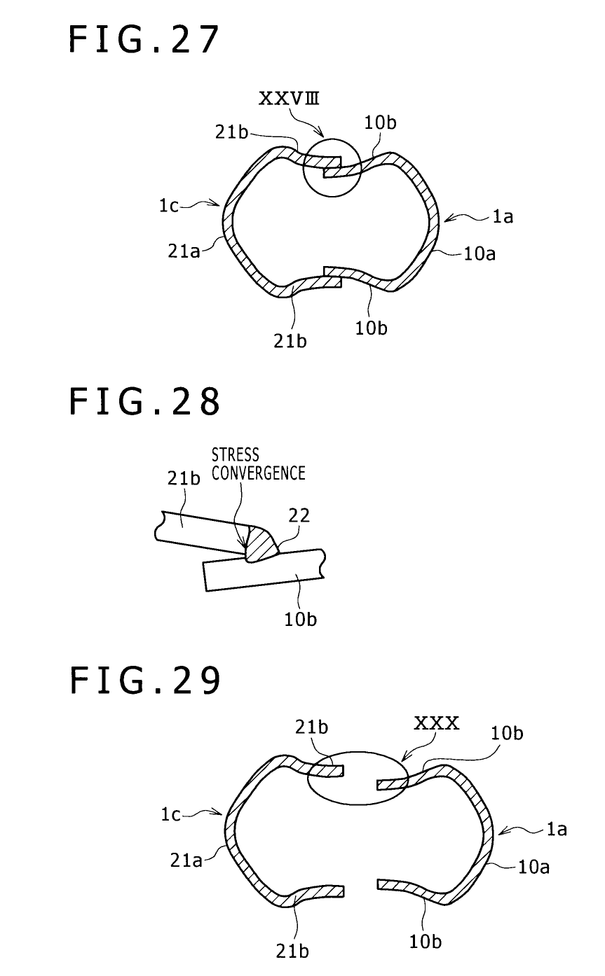

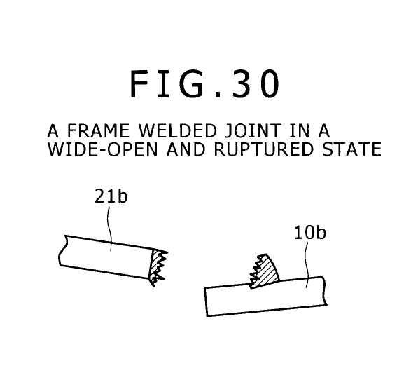

In FIGS. 26 to 30, respectively, there is shown the ruptured state of each of the frames according to Comparative Example 2. In FIGS. 26 to 30, constituents identical to those in FIGS. 1 to 25 are denoted by like reference numerals, thereby omitting detailed description thereof. With the frame according to Comparative Example 2, having the lap joint, stress converges at a point of intersection of the welded joint 22, and an interface between the first side part 10b, and the second side part 21b, so that the welded joint 22 was found ruptured and wide open. With the frame according to Comparative Example 2, having the butt joint, as well, stress converges in the vicinity of the welded joint 22, resulting in rupture of the welded joint 22, however, the welded joint 22 was not found open as wide as in the case of the frame according to Comparative Example 2, having the lap joint.

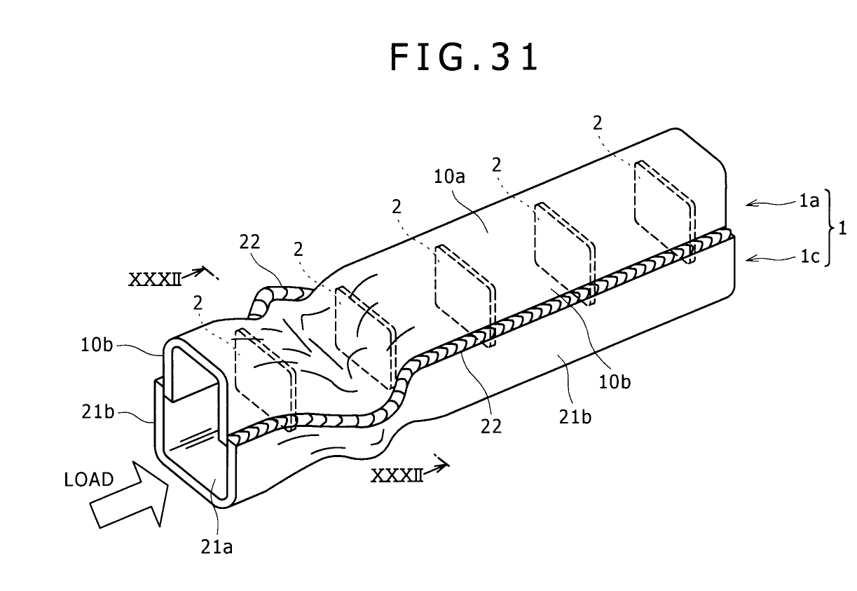

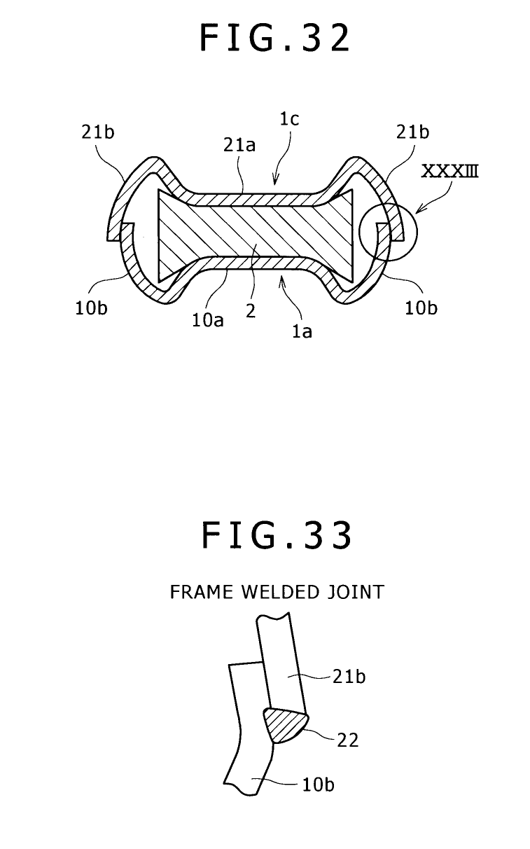

On the other hand, with the frame according to Working Example 2, that is, the frame wherein the reinforcing plate 2a are joined to the inner sides of the body 1, the respective side parts of the body 1, where the welded joint 22 was located, underwent deformation in the state of outward protrusion, as shown in FIGS. 31 to 33, so that the respective welded joints 22 were prevented from being ruptured to be in a wide-open state although cracking occurred to the welded joints 22. This is presumably because if the respective side parts of the body 1 undergo the deformation in the state of outward protrusion, convergence of stress does not occur at the point of the intersection of the welded joint 22, and the interface between the first side part 10b, and the second side part 21b, so that there did not occur such a rupture as large as to cause the welded joint 22 to be wide open. Further, the ruptured state of the frame according to Working Example 1 was found to the same as that of the frame according to Working Example 2.

Further, with the frame according to any of Working Examples 3 to 7, the welded joint 32 (22) was not found wide open and ruptured. However, with the frame wherein the reinforcing plate 3a, and the second frame member 1b were joined together by the MIG welding only at the respective inner side faces of the second side parts 11b, 11b, as in the case of the third embodiment, rupture occurred to respective portions of the welded joint, corresponding to a region between the respective reinforcing plates 3a although no rupture occurred to portions of the welded joint 32 extending in the axial direction of the body 1, corresponding to respective sites where the reinforcing plate 3a was located. However, the welded joint 32 was not found ruptured and wide open as shown in FIG. 26.

Further, with the frame according to Working Example 4, wherein the reinforcing plate 3a, and the second frame member 1b were joined together only at the inner side face of the second bottom 11a, the respective side parts of the body 1 underwent deformation in the state of outward protrusion, but the respective welded joints 32 did not undergo rupture to be wide open, as shown in FIG. 26.

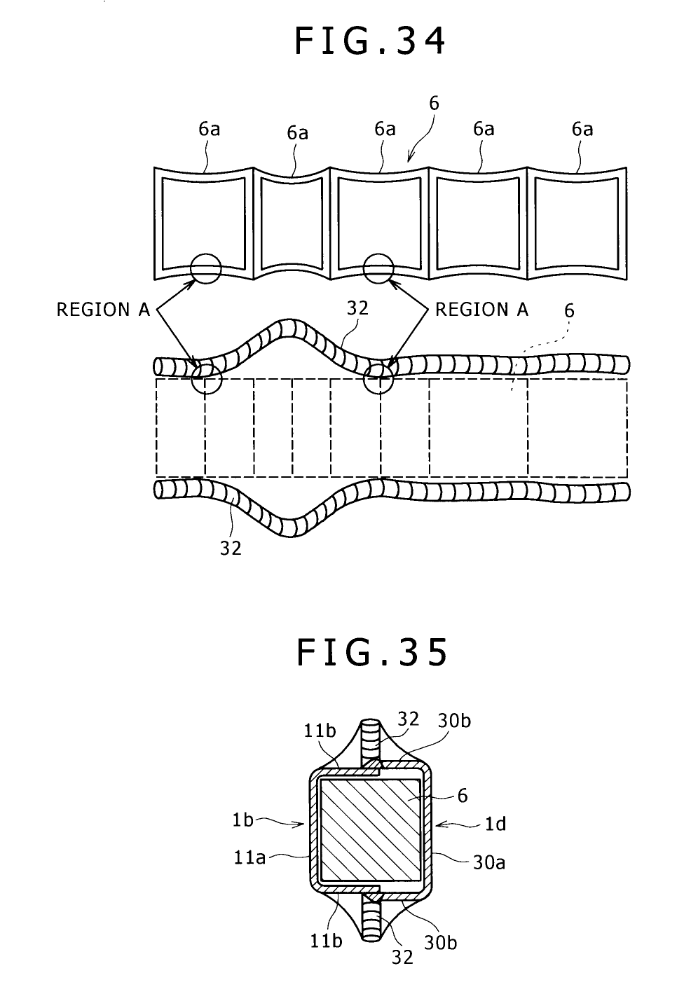

Further, with the frame according to Working Example 7, a wall-part of each of the extruded shapes 6a making up the internal reinforcing member 6 was found inwardly dented, as shown in FIG. 34, however, a portion (at a site A in FIG. 34) of the welded joint 32, before and after a site of the wall-part, having undergone the largest deformation, was not found deformed in such a way as to be inwardly dented. In the case of the frame according to Working Example 7, concurrently with compression deformation of the body 1, in the axial direction (the longitudinal direction) thereof, the internal reinforcing member 6 as well undergoes deformation, and the sites A shown in FIG. 34 support the body 1 from within. As a result, both the side parts of the body 1, where the welded joint 32 is located, is reinforced, which is presumed to be the reason why the welded joint 32 was not deformed in such a way as to be inwardly dented. It was found out that the frame according to Working Example 7 had the least number of occurrences of fracture (cracking) of the welded joint 32 among all Working Examples, and all Comparative Examples.

It has turned out on the basis of the results described in the foregoing that in a frame for making up closed cross-sections by welding two pieces of frame members made of an aluminum alloy with each other, if an internal reinforcing member is disposed inside the frame such that the internal reinforcing member is butted against the inner side faces of the frame members, it is possible to prevent the welded joint from being opened up when an external force is applied to the frame upon collision with a vehicle, and so forth, causing the frame to be collapsed. Accordingly, with the frame made up as above, it is possible to prevent not only deterioration in energy absorption performance upon collapsing of the frame, but also injury inflicted to passengers, and damage to an ambient environment, caused by the welded joint being opened and ruptured to thereby cause a sharp ruptured face to be exposed.

It is to be understood that the present embodiments and working examples disclosed in the foregoing are illustrative and not restrictive in every aspect. It should also be understood that the scope of the invention is defined by the appended claims rather than by the description preceding them, and all changes that fall within meets and bounds of the claims, or equivalence of such meets and bounds are therefore intended to be embraced by the claims.

For example, the third and fourth embodiments, respectively, are not limited to a form in which the body 1 is formed by fillet-welding the first side parts 30b of the first frame member 1d to the second side parts 11b of the second frame member 1b, respectively, with the lap joint, as shown in FIGS. 9 to 14. More specifically, the body 1 formed by welding the first frame member 1a to the second frame member 1b with the butt joint, as in the case of the first embodiment shown in FIG. 1, may be applied to the third and fourth embodiments, respectively,

Further, the sixth embodiment is not limited to a form in which the body 1 is formed by fillet-welding the first side parts 10b of the first frame member 1a to the second side parts 21b of the second frame member 1c, respectively, with the lap joint, as shown in FIGS. 17, and 18. More specifically, the body formed by welding respective ends of the side parts of two frame members with each other by use of a butt joint may be applied to the sixth embodiment.

Still further, the reinforcing plates 2a, 3a, 4a, and 5a in each of the first to sixth embodiments were provided at equal intervals, however, those reinforcing plates need not necessarily be provided at equal intervals, and may be provided at adequate intervals in consideration of the external and internal structures of a frame.

Yet further, for the extruded shape 6a making up the internal reinforcing member 6, in the seventh embodiment, use was made of shapes identical in sectional shape, obtained by cutting one and the same extruded shape, however, the shapes identical in sectional shape need not necessarily be used. It is possible to use plural types of shapes inconsideration of inconsideration of the internal structure of a frame.

Still further, the seventh embodiment is not limited to a form in which the body 1 is formed by fillet-welding the first side parts 30b of the first frame member 1d to the second side parts 11b of the second frame member 1b, respectively, with the lap joint, as shown in FIGS. 20, and 21. More specifically, the body formed by welding respective ends of the side parts of two frame members with each other by use of a butt joint may be applied to the seventh embodiment.

The invention is summed up as follows. More specifically, a frame having closed cross-sections, according to invention, is a frame having closed cross-sections, provided with a body cylindrical in shape, the frame including a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located. And the internal reinforcing member includes plural reinforcing plates disposed in such a way as to intersect the axial direction of the body, and at equal intervals in the axial direction of the body, respective end faces of each of the reinforcing plates, in the widthwise direction of the body, having a portion butted against the inner side face of the second side part, corresponding thereto, and a portion disposed so as to be isolated from the inner side face of the first side part, corresponding thereto, and one end face of the reinforcing plate, in the direction of height, orthogonal to the widthwise direction of the body, is butted against the inner side face of the first bottom while the other end face thereof is butted against the inner side face of the second bottom.

With the frame having the closed cross-sections, there are provided the reinforcing plates making up the internal reinforcing member, disposed in such a way as to intersect the axial direction of the body, and the respective end faces of the reinforcing plate, in the widthwise direction of the body, has the portion butted against the inner side face of the first side part, corresponding thereto. When an external force is applied in the longitudinal direction of the frame having the closed cross-sections at the time of vehicle collision, and so forth, the frame is collapsed in the axial direction thereof, thereby absorbing energy generated by the external force. With the frame having the closed cross-sections, since compressive strength of the frame, in a direction in which a pair of welded joints for joining the first frame member to the second frame member are aligned with each other, is rendered higher than compressive strength in any direction orthogonal thereto by the action of the reinforcing plates provided as described above, at this point in time, the respective side parts of the body, where the welded joint is located, are prevented from undergoing deformation in such a way as to be inwardly dented. Hence, the respective welded joints are prevented from being opened, and undergoing rupture. Accordingly, when an external force is applied to the frame at the time of vehicle collision, and so forth, thereby causing the frame to be collapsed, it is possible to prevent the welded joint from being turned in a wide open state, or broken. Further, with the frame described, since the reinforcing plate is butted against the inner side face of the first bottom, and the inner side face of the second bottom, rigidity of the frame, in the direction of the height thereof, can be enhanced. Still further, with the frame described, since the reinforcing plate is butted against both the first frame member and the second frame member, energy propagated from both the frame members can be absorbed to a degree through deformation of the reinforcing plates. Hence, it is possible to enhance absorption performance against the energy generated by the external force as compared with the case of a configuration where the reinforcing plate is butted only against either the first frame member or the second frame member.

Further, a frame having closed cross-sections, according to invention, is a frame having closed cross-sections, provided with a body cylindrical in shape, the frame including a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located. And the internal reinforcing member includes plural reinforcing plates disposed in such a way as to intersect the axial direction of the body, and at equal intervals in the axial direction of the body, an end of the second side part, on a side thereof, opposite from the second bottom, in a state of overlapping the outer side of an end of the first side part, on a side thereof, opposite from the first bottom, is fillet-welded to an outer side face of the first side part, respective end faces of the reinforcing plate, in the widthwise direction of the body, are butted against respective inner side faces of the first side parts, corresponding thereto, and one end face of the reinforcing plate, in the direction of height, orthogonal to the widthwise direction of the body, is butted against the inner side face of the first bottom while the other end face thereof is butted against the inner side face of the second bottom.

With the frame having the closed cross-sections, there are provided the reinforcing plates making up the internal reinforcing member, disposed in such a way as to intersect the axial direction of the body, and the respective end faces of the reinforcing plate, in the widthwise direction of the body, are butted against the respective inner side faces of the first side parts, corresponding thereto. With the frame having the closed cross-sections, since compressive strength of the frame, in a direction in which a pair of welded joints for joining the first frame member to the second frame member are aligned with each other, is rendered higher than compressive strength in any direction orthogonal thereto by the action of the reinforcing plates provided as described above, the respective side parts of the body, where the welded joint is located, are prevented from undergoing deformation in such a way as to be inwardly dented. Hence, the respective welded joints are prevented from being opened, and undergoing rupture. Accordingly, when an external force is applied to the frame described at the time of vehicle collision, and so forth, thereby causing the frame to be collapsed, it is possible to prevent the welded joint from being turned in a wide open state, and being ruptured. Further, with the frame described, the one end face of the reinforcing plate, in the direction of height, orthogonal to the widthwise direction of the body, is butted against the inner side face of the first bottom while the other end face thereof is butted against the inner side face of the second bottom. Accordingly, when fillet-welding is executed by causing the end of the second side part, on the side thereof, opposite from the second bottom, to overlap the outer side of the end of the first side part, on the side thereof, opposite from the first bottom, it is possible to accurately execute positioning of the first frame member in relation to the second frame member such that the end of the first side part, and the end of the second side part overlap each other at an overlapping length as desired by butting the end of the first side part, on the side thereof, opposite from the first bottom, against the one end face of the reinforcing plate.

Still further, a frame having closed cross-sections, according to invention, is a frame having closed cross-sections, provided with a body cylindrical in shape, the frame including a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located. And the reinforcing member includes an axial direction member extended in the axial direction of the body, and plural reinforcing plates disposed in such a way as to intersect the axial direction of the body, and at equal intervals in the axial direction of the body, the axial direction member has plural incisions provided at equal intervals in the axial direction of the body, each of the reinforcing plates being inserted into the respective incisions, respective end faces of the reinforcing plate, in the widthwise direction of the body, are butted against respective inner side faces of the first side parts, corresponding thereto, and an end face of the reinforcing plate, positioned on one side, in the direction of height, orthogonal to the widthwise direction of the body, is butted against the inner side face of the first bottom while an end face of the axial direction member, positioned on the other side, in the direction of the height, is butted against the inner side face of the second bottom.

With this frame having the closed cross-sections, there are provided the reinforcing plates making up the internal reinforcing member, disposed in such a way as to intersect the axial direction of the body, and the respective end faces of the reinforcing plate, in the widthwise direction of the body, are butted against the respective inner side faces of the first side parts, corresponding thereto. When an external force is applied to the frame having the closed cross-sections at the time of vehicle collision, and so forth, the frame is collapsed, thereby causing the external force to be absorbed. With the frame having the closed cross-sections, since compressive strength of the frame, in a direction in which a pair of welded joints for joining the first frame member to the second frame member are aligned with each other, is rendered higher than compressive strength in any direction orthogonal thereto by the action of the reinforcing plates provided as described above, at this point in time, the respective side parts of the body, where the welded joint is located, are prevented from undergoing deformation in such a way as to be inwardly dented. Hence, the respective welded joints are prevented from being opened, and undergoing rupture. Accordingly, when an external force is applied to the frame at the time of vehicle collision, and so forth, thereby causing the frame to be collapsed, it is possible to prevent the welded joint from being turned into a wide-open state or being broken. Further, since this frame is provided with the axial direction member extended in the axial direction of the body, rigidity of the frame, in the axial direction thereof, can be enhanced. On the other hand, since the axial direction member is provided with the plural the incisions along the axial direction of the body, rigidity (compressive strength) of the frame, in the axial direction thereof, is prevented from becoming excessively high. In so doing, even though the axial direction member is provided, and the rigidity of the frame, in the axial direction thereof, is thereby enhanced, it is possible to prevent collapse of the frame, in the axial direction thereof, when the external force is applied, from being interfered. In addition, with this frame, since the end face of the reinforcing plate, positioned on one side, in the direction of the height of the body, is butted against the inner side face of the first bottom while the end face of the axial direction member, positioned on the other side, is butted against the inner side face of the second bottom, it is possible to enhance rigidity of the frame, in the direction of the height thereof. Furthermore, the reinforcing member is butted against both the first frame member, and the second frame member, so that the absorption performance against the energy generated by the external force can be enhanced.

Yet further, a frame having closed cross-sections, according to invention, is a frame having closed cross-sections, provided with a body cylindrical in shape, the frame including a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located. And the internal reinforcing member includes plural extruded shapes cylindrical in shape, arrayed in the axial direction of the body, and provided so as to be butted against an inner side face of the first bottom, respective inner side faces of the first side parts, an inner side face of the second bottom, and an inner side face of the second side part, the respective extruded shapes being disposed such that the axial directions of the respective extruded shapes coincide with a direction in which a pair of the welded joints, each joining an open end of the first frame member to an open end of the second frame member, are aligned with each other, and the extruded shapes adjacent to each other, in the axial direction of the body, are joined with each other.

With this frame having the closed cross-sections, the plural the extruded shapes cylindrical in shape, making up the internal reinforcing member, are arrayed along the axial direction of the body, inside the body, the respective extruded shapes are butted against the respective inner side faces of the first bottom, the first side parts, the second bottom, and the second side parts, and the respective extruded shapes are disposed such that the axial directions of the respective extruded shapes coincide with the direction in which the pair of the welded joints are aligned with each other, and the extruded shapes adjacent to each other, in the axial direction of the body, are joined with each other. When an external force is applied to the frame having the closed cross-sections at the time of vehicle collision, and so forth, the frame is collapsed, thereby causing the external force to be absorbed. With the frame having the closed cross-sections, since compressive strength of the frame, in the direction in which the pair of welded joints are aligned with each other is rendered higher than compressive strength in any direction orthogonal thereto by the action of the extruded shapes 6a of the reinforcing member, as described above, at this point in time, the respective side parts of the body, where the welded joint is located, are prevented from undergoing deformation in such a way as to be inwardly dented. Hence, the respective welded joints are prevented from being opened, and undergoing rupture. Further, with this frame, the extruded shapes are arrayed along the axial direction of the body, and the extruded shapes adjacent to each other, in the axial direction of the body, are joined with each other, so that the rigidity of the frame, in the axial direction thereof, can be enhanced. On the other hand, the extruded shapes are disposed such that the axial directions of the respective extruded shapes 6a cylindrical in shape are aligned with the direction in which the pair of the welded joints are aligned with each other, that is, the crosswise direction of the body, so that the rigidity of the frame, in the axial direction thereof, becomes lower as compared with rigidity of the frame, in the crosswise direction of the body. Accordingly, the rigidity (compressive strength) of the frame, in the axial direction thereof, is prevented from becoming excessively high, and the collapse of the frame, in the axial direction thereof, when the external force is applied, can be prevented from being interfered. Furthermore, with this frame, since the internal reinforcing member is butted against the inner side face of the first bottom, and the inner side face of the second bottom, it is possible to enhance rigidity of the frame, in the direction of the height of the body. In addition, since the reinforcing member is butted against both the first frame member, and the second frame member, the absorption performance against the energy generated by the external force can be enhanced.

A frame having closed cross-sections, according to invention, is a frame having closed cross-sections, provided with a body cylindrical in shape, the frame including a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located. And the internal reinforcing member includes plural reinforcing plates disposed in such a way as to intersect the axial direction of the body, and at equal intervals in the axial direction of the body, respective end faces of each of the reinforcing plates, in the widthwise direction of the body, are butted against respective inner side faces of the first side parts, corresponding thereto, and one end face of the reinforcing plate, in the direction of height, orthogonal to the widthwise direction of the body, is butted against the inner side face of the first bottom while the other end face thereof is disposed so as to be isolated from the second frame member.

With the frame having the closed cross-sections, there are provided the reinforcing plates making up the internal reinforcing member, disposed in such a way as to intersect the axial direction of the body, and the respective end faces of the reinforcing plate, in the widthwise direction of the body, are butted against the respective inner side faces of the first side parts, corresponding thereto. When an external force is applied in the longitudinal direction of the frame having the closed cross-sections at the time of vehicle collision, and so forth, the frame is collapsed in the axial direction thereof, thereby absorbing energy generated by the external force. With the frame having the closed cross-sections, since compressive strength of the frame, in a direction in which a pair of welded joints for joining the first frame member to the second frame member are aligned with each other, is rendered higher than compressive strength in any direction orthogonal thereto by the action of the reinforcing plates provided as described above, at this point in time, the respective side parts of the body, where the welded joint is located, are prevented from undergoing deformation in such a way as to be inwardly dented. Hence, the respective welded joints are prevented from being opened, and undergoing rupture. Accordingly, when an external force is applied to the frame described at the time of vehicle collision, and so forth, thereby causing the frame to be collapsed, it is possible to prevent the welded joint from being turned in a wide open state, or being broken.

Further, with the frame having the closed cross-sections, either an end of the first side part, on a side thereof, opposite from the first bottom, or an end of the second side part, on a side thereof, opposite from the second bottom, in a state of overlapping the outer side of the other end, may be fillet-welded to the outer side face of the other end.

Still further, with the frame having the closed cross-sections, the first frame member and the second frame member may be made up of an extruded shape made of an aluminum alloy.

1. A frame having closed cross-sections, provided with a body cylindrical in shape, said frame comprising a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located,
wherein
the internal reinforcing member comprises a plurality of reinforcing plates disposed in such a way as to intersect the axial direction of the body, and at equal intervals in the axial direction of the body, respective end faces of each of the reinforcing plates, in the widthwise direction of the body, having a portion butted against the inner side face of the second side part, corresponding thereto, and a portion disposed so as to be isolated from the inner side face of the first side part, corresponding thereto, and one end face of the reinforcing plate, in the direction of height, orthogonal to the widthwise direction of the body, is butted against the inner side face of the first bottom while the other end face thereof is butted against the inner side face of the second bottom.

2. A frame having closed cross-sections, provided with a body cylindrical in shape, said frame comprising a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located,
wherein
the internal reinforcing member comprises a plurality of reinforcing plates disposed in such a way as to intersect the axial direction of the body, and at equal intervals in the axial direction of the body, an end of the second side part, on a side thereof, opposite from the second bottom, in a state of overlapping the outer side of an end of the first side part, on a side thereof, opposite from the first bottom, is fillet-welded to an outer side face of the first side part, respective end faces of the reinforcing plate, in the widthwise direction of the body, are butted against respective inner side faces of the first side parts, corresponding thereto, and one end face of the reinforcing plate, in the direction of height, orthogonal to the widthwise direction of the body, is butted against the inner side face of the first bottom while the other end face thereof is butted against the inner side face of the second bottom.

3. A frame having closed cross-sections, provided with a body cylindrical in shape, said frame comprising a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located,
wherein
the internal reinforcing member comprises an axial direction member extended in the axial direction of the body, and a plurality of reinforcing plates disposed in such a way as to intersect the axial direction of the body, and at equal intervals in the axial direction of the body, the axial direction member has a plurality of incisions provided at equal intervals in the axial direction of the body, each of the reinforcing plates being inserted into the respective incisions, respective end faces of the reinforcing plate, in the widthwise direction of the body, are butted against respective inner side faces of the first side parts, corresponding thereto, and an end face of the reinforcing plate, positioned on one side, in the direction of height, orthogonal to the widthwise direction of the body, is butted against the inner side face of the first bottom while an end face of the axial direction member, positioned on the other side, in the direction of the height, is butted against the inner side face of the second bottom.

4. A frame having closed cross-sections, provided with a body cylindrical in shape, said frame comprising a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located,
wherein
the internal reinforcing member comprises a plurality of extruded shapes cylindrical in shape, arrayed in the axial direction of the body, and provided so as to be butted against an inner side face of the first bottom, respective inner side faces of the first side parts, and an inner side face of the second bottom, the respective extruded shapes being disposed such that the axial directions of the respective extruded shapes coincide with a direction in which a pair of the welded joints, each joining an open end of the first frame member to an open end of the second frame member, are aligned with each other, and the extruded shapes adjacent to each other, in the axial direction of the body, are joined with each other.

5. A frame having closed cross-sections, provided with a body cylindrical in shape, said frame comprising a first frame member having a first bottom, and a pair of first side parts, each being erected from the first bottom, and disposed so as to be opposed to each other with spacing interposed therebetween, a second frame member having a second bottom, and a pair of second side parts, each being erected from the second bottom, and disposed so as to be opposed to each other with spacing interposed therebetween, respective ends of the second side parts, being welded to respective ends of the first side parts, corresponding thereto, the second frame member, together with the first frame member, making up the body, and an internal reinforcing member, installed inside the body, for controlling inward denting of both the side parts of the body, where a welded joint between the first side part and the second side part is located,
wherein
the internal reinforcing member comprises a plurality of reinforcing plates disposed in such a way as to intersect the axial direction of the body, and at equal intervals in the axial direction of the body, respective end faces of each of the reinforcing plates, in the widthwise direction of the body, are butted against respective inner side faces of the first side parts, corresponding thereto, and one end face of the reinforcing plate, in the direction of height, orthogonal to the widthwise direction of the body, is butted against the inner side face of the first bottom while the other end face thereof is disposed so as to be isolated from the second frame member.

6. The frame having closed cross-sections, according to claim 1, wherein either an end of the first side part, on a side thereof, opposite from the first bottom, or an end of the second side part, on a side thereof, opposite from the second bottom, in a state of overlapping the outer side of the other end, is fillet-welded to the outer side face of the other end.

7. The frame having closed cross-sections, according to claim 1, wherein the first frame member and the second frame member include an extruded shape made of an aluminum alloy.

8. The frame having closed cross-sections, according to claim 3, wherein either an end of the first side part, on a side thereof, opposite from the first bottom, or an end of the second side part, on a side thereof, opposite from the second bottom, in a state of overlapping the outer side of the other end, is fillet-welded to the outer side face of the other end.

9. The frame having closed cross-sections, according to claim 4, wherein either an end of the first side part, on a side thereof, opposite from the first bottom, or an end of the second side part, on a side thereof, opposite from the second bottom, in a state of overlapping the outer side of the other end, is fillet-welded to the outer side face of the other end.

10. The frame having closed cross-sections, according to claim 5, wherein either an end of the first side part, on a side thereof, opposite from the first bottom, or an end of the second side part, on a side thereof, opposite from the second bottom, in a state of overlapping the outer side of the other end, is fillet-welded to the outer side face of the other end.

11. The frame having closed cross-sections, according to claim 2, wherein the first frame member and the second frame member include an extruded shape made of an aluminum alloy.

12. The frame having closed cross-sections, according to claim 3, wherein the first frame member and the second frame member include an extruded shape made of an aluminum alloy.

13. The frame having closed cross-sections, according to claim 4, wherein the first frame member and the second frame member include an extruded shape made of an aluminum alloy.

14. The frame having closed cross-sections, according to claim 5, wherein the first frame member and the second frame member include an extruded shape made of an aluminum alloy.

15. The frame having closed cross-sections, according to claim 6, wherein the first frame member and the second frame member include an extruded shape made of an aluminum alloy.

16. The frame having closed cross-sections, according to claim 8, wherein the first frame member and the second frame member include an extruded shape made of an aluminum alloy.

17. The frame having closed cross-sections, according to claim 9, wherein the first frame member and the second frame member include an extruded shape made of an aluminum alloy.

18. The frame having closed cross-sections, according to claim 10, wherein the first frame member and the second frame member include an extruded shape made of an aluminum alloy.
